(19) United States
(12) Patent Application Publication
(10) Pub. No.: US 2005/0077357 A1
(43) Pub. Date: Apr. 14, 2005

(54) Contactless card reader

(76) Inventor: Pascal Roux, Chabeuil (FR)

Correspondence Address: Edward J. Howard;PLEVY & HOWARD, PC, Post Office Box 226, Fort Washington, PA, 19034, US

(21) Appl. No.: 10/936,967

(22) Filed: Sep. 9, 2004

(30) Foreign Application Priority Data
Sep. 10, 2003 (FR) 03/50519

(51) Int. Cl. G06K 7/08

(52) U.S. Cl. 235/451

(57) ABSTRACT

A contactless card reader comprising an enclosure containing a control circuit connected to a first antenna and capable of remotely exchanging data by the coupling between the first antenna and the antenna of a contactless card. The enclosure contains a diagnosis device comprising a second antenna connected to a test circuit via a switch and means for providing a switch control signal, said test circuit being capable, with no presented contactless card, of exchanging data with the control circuit by the coupling of the first and second antennas when the switch is on to perform a diagnosis of the reader.

### BACKGROUND OF THE INVENTION

1. Field of the Invention

The present invention relates to a contactless card reader. More specifically, the present invention relates to the diagnosis of a contactless card reader.

2. Discussion of the Related Art

A contactless card reader generally comprises an inductance, for example, formed of a single spiral, also called the reader antenna. A user places, close to the reader antenna, a card on which is attached an integrated circuit, called the card chip, connected to an inductance forming the card antenna. A coupling occurs between the two antennas, enabling data exchange between the reader's processing circuit and the card chip. There exist different chip types which communicate with the processing circuit according to different data exchange protocols. A reader must preferably be capable of communicating with any chip type. Further, a reader must be capable of communicating with a chip when the card supporting the chip is placed in front of the reader's antenna at a distance varying within a determined range, for example from 0 to 10 centimeters.

It is necessary to regularly make a diagnosis of the reader to determine whether it operates properly. A serious failure may correspond to the case where the reader can no longer communicate with a card independently from the type of the chip associated with the card or from the distance separating the card from the reader's antenna. An example of a partial failure corresponds to the case where the reader communicates with a chip of a determined type but can no longer communicate with other types of chips. Another example of a partial failure corresponds to the case where the reader communicates with a chip only when the card supporting the chip is placed at a distance from the reader's antenna belonging to a range different from the usual distance range.

Generally, the diagnosis of a reader is performed by bringing close to the reader a conventional contactless card used as a test card. It is then verified whether the data exchange between the reader and the card chip occurs correctly. Such a diagnosis thus requires the presence of an operator. Further, such a diagnosis enables only testing whether the reader can communicate with a determined type of chip, that of the chip supported by the test card. To make sure that the reader can communicate with a different type of chip, it is necessary to use a new test card supporting such a chip, which considerably increases the number of operations to be performed in a diagnosis. Further, it is difficult, with such a diagnosis, to verify whether the reader can communicate with a contactless card chip for all the values of the normally accepted distance separating the reader's antenna from the card. Further, such a diagnosis is delicate to implement for a group of readers since a test card much be presented in front of each reader to be diagnosed.

### SUMMARY OF THE INVENTION

The present invention aims at a contactless card reader enabling implementation of an automatic diagnosis of the reader.

Another object of the present invention is to obtain a contactless card reader, the diagnosis of which can be remotely controlled.

To achieve these objects, the present invention provides a contactless card reader comprising an enclosure containing a control circuit connected to a first antenna and capable of remotely exchanging data by the coupling between the first antenna and the antenna of a contactless card, wherein the enclosure contains a diagnosis device comprising a second antenna connected to a test circuit via a switch and a means for providing a switch control signal, said test circuit being capable, with no presented contactless card, of exchanging data with the control circuit by the coupling of the first and second antennas when the switch is on to perform a diagnosis of the reader.

According to an embodiment of the present invention, the reader comprises a supporting base, the first antenna comprising a spiral at the level of a surface of the supporting base, the spiral delimiting an inner portion of said surface, the second antenna being located at the level of the inner portion.

According to an embodiment of the present invention, the reader comprises a first supporting base, the first antenna comprising a spiral on a substantially planar surface of the first supporting base, and a second supporting base, the second antenna being located on a substantially planar surface of the second supporting base.

According to an embodiment of the present invention, the reader comprises a means for displacing the second supporting base with respect to the first supporting base in a direction substantially parallel to the surface of the first supporting base to simulate the presentation of a contactless card at a variable distance from the reader.

According to an embodiment of the present invention, the reader comprises a means for displacing the second supporting base with respect to the first supporting base in a direction substantially perpendicular to the surface of the first supporting base to simulate the presentation of a contactless card at a variable distance from the reader.

According to an embodiment of the present invention, the reader comprises a means for modifying the inductance of the second antenna and/or the coupling coefficient of the second antenna with the first antenna to simulate the presentation of a contactless card at a variable distance from the reader.

According to an embodiment of the present invention, the reader comprises a means for selecting an inductance value of the second antenna and/or of the coupling coefficient of the second antenna with the first antenna from among several discrete values.

According to an embodiment of the present invention, the reader comprises a first test circuit, a second test circuit, and a means for connecting the second antenna selectively to the first or to the second test circuit, the first test circuit being capable, when connected to the second antenna, of exchanging data with the control circuit according to first operating conditions of the control circuit, the second test circuit being capable, when connected to the second antenna, of exchanging data with the control circuit according to second operating conditions of the control circuit.

According to an embodiment of the present invention, the control circuit is connected to the first antenna by a coaxial cable, the means for providing the control signal of the switch comprising a low-pass filter connected to the coaxial cable.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1 schematically shows an example of the forming of a contactless card reader according to the present invention;

FIG. 2 shows an alternative of the reader of FIG. 1; and

FIGS. 3 to 5 show three more detailed examples of the forming of the contactless card reader of FIG. 1.

### DETAILED DESCRIPTION

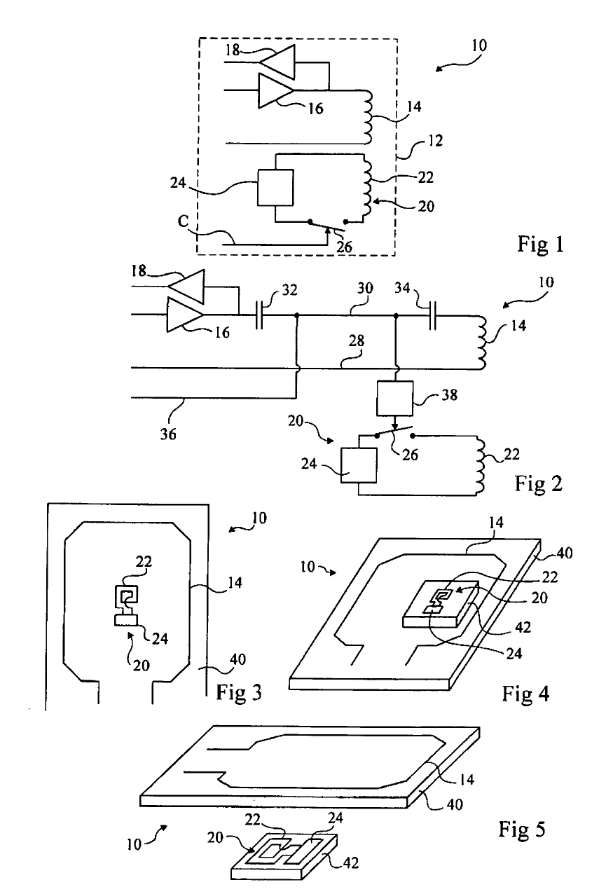

FIG. 1 shows a reader 10 formed of an enclosure 12 (shown by dotted lines) containing an antenna 14, called the reader antenna, connected to a transmit amplifier 16 and to a receive amplifier 18, themselves connected to a data processing circuit, not shown, called the reader control circuit. Upon normal operation of reader 10, a contactless read card, not shown, comprising an antenna connected to an integrated circuit, called the card chip, is placed close to enclosure 12 at the level of antenna 14 of reader 10. A coupling occurs between antenna 14 of reader 10 and the card antenna, enabling exchange of signals between the reader control circuit and the card chip.

The present invention consists of providing, in enclosure 12, a diagnosis device 20 having a structure similar to that of the circuit supported by a contactless card. Diagnosis device 20 comprises a diagnosis antenna 22, arranged in enclosure 12 and connected to a data processing circuit dedicated to making a diagnosis, called diagnosis chip 24. A switch 26 is arranged between a terminal of diagnosis antenna 22 and a terminal of diagnosis chip 24. Switch 26 is remotely controlled via a control signal C. It is, for example, formed of one or several transistors.

When switch 26 is off, there is no interaction between diagnosis antenna 22 and antenna 14 of reader 10. Reader 10 may then operate normally for the contactless reading of cards placed outside of enclosure 12 close to antenna 14 of reader 10. When switch 26 is on, a coupling occurs between diagnosis antenna 22 and antenna 14 of reader 10, enabling data exchange between diagnosis chip 24 and the reader control circuit. It is then possible to detect a malfunction of reader 10 by an analysis of the data exchanged with diagnosis chip 24. A diagnosis of reader 10 is performed when no card is presented at the level of antenna 14 of reader 10 outside of enclosure 12.

Diagnosis chip 24 may operate similarly to a chip usually equipping a card used with reader 10. However, diagnosis chip 24 is not intended to perform all the functions of a conventional chip equipping a contactless read card. Indeed, diagnosis chip 24 only participates in the making of a diagnosis to detect an operation failure of reader 10. It is thus not necessary for diagnosis chip 24 to have as complex a structure as a conventional chip equipping a contactless read card. In particular, diagnosis chip 24 may comprise components reproducing well enough the operation of a conventional chip only for the steps necessary to the making of the diagnosis of reader 10.

The control signal of switch 26 may advantageously be provided by a remote diagnosis center connected to one or several readers equipped with the diagnosis device according to the present invention. The diagnosis of a reader assembly can then be automatically made by a single remote center.

FIG. 2 shows an alternative of reader 10 in which antenna 14 of reader 10 is transferred away from the control circuit and connected thereto by a coaxial cable comprising a reference line 28 and an active line 30. Diagnosis device 20 is identical to the example of FIG. 1. A first coupling capacitor 32 is arranged between amplifiers 16, 18 and active line 30 and a second coupling capacitor 34 is arranged between active line 30 and antenna 14 of reader 10. A conductive wire 36 conducts the control signal to active line 30 downstream of first coupling capacitor 32. A low-pass filter 38 is connected to active line 30 upstream of second coupling capacitor 34 and provides the control signal to switch 26 of diagnosis device 20. Such an alternative of the present invention enables adapting diagnosis device 20 according to the present invention to a reader 10 with an offset antenna 14.

FIG. 3 shows a first more detailed example of the forming of reader 10 according to the present invention. According to the first more detailed example, antenna 14 of reader 10 is formed of a single spiral formed on a supporting base 40. Amplifiers 16, 18 are not shown. Diagnosis device 20 is formed at the level of supporting base 40 inside of spiral 14. Only chip 24 and diagnosis antenna 22 are shown, diagnosis antenna 22 being, as an example, shown with two concentric spirals. The surface area taken up by diagnosis antenna 22 and the number of spirals of diagnosis antenna 22 determine the value of the inductance of diagnosis antenna 22. The coupling characteristics between diagnosis antenna 22 and antenna 14 of reader 10 can thus be set. The coupling between antenna 14 of reader 10 and an antenna of a contactless card reader placed at a given distance from supporting base 40 of antenna 14 of reader 10 can thus be simulated.

FIG. 4 shows a second more detailed example of the forming of reader 10 according to the present invention. According to the second example, diagnosis device 20 is formed at the level of an auxiliary supporting base 42 separate from supporting base 40 associated with antenna 14 of reader 10, and arranged in the enclosure of reader 10 (not shown). Supporting base 42 is arranged level with supporting base 40 to consider that diagnosis antenna 22 is substantially comprised in the plane of antenna 14 of reader 10. According to an alternative of the second example, diagnosis antenna 22 is formed at the level of the surface of auxiliary supporting base 42 opposite to supporting base 40. A displacement mechanism, not shown, is capable of displacing auxiliary supporting base 42 with respect to supporting base 40 while maintaining auxiliary supporting base 42 tangent to supporting base 40. By modifying the relative position between diagnosis antenna 22 and antenna 14 of reader 10, the coupling between diagnosis antenna 22 and reader antenna 14 can be modified and the presentation of a contactless read card in front of reader 10 at a variable distance can be simulated. Such a modification of the coupling is especially obtained by displacing supporting base 42 so that diagnosis antenna 22 overlaps more or less the single spiral of antenna 14 of reader 10. The second example thus enables making the diagnosis of reader 10 as if a contactless read card supporting chip 24 were presented at different distances in front of antenna 14 of reader 10. The second example enables in particular detecting a partial failure corresponding to the case where reader 10 communicates with a contactless read card only when it is placed close to antenna 14 of reader 10 at a distance belonging to a distance range different from the range for which the reader should normally communicate with the card chip.

FIG. 5 shows a third more detailed example of the forming of reader 10 according to the present invention. According to the third example, auxiliary supporting base 42 associated with diagnosis device 20 is adapted to being displaced with respect to supporting base 40 of antenna 14, while remaining contained in the enclosure, not shown, of reader 10, in a direction substantially perpendicular to the surface of supporting base 40 at the level of which is formed antenna 14 of reader 10. The operation of reader 10 can be tested at different distances separating diagnosis antenna 22 from antenna 14 of reader 10. The third embodiment requires for the enclosure of reader 10 containing supporting bases 40, 42, to be sufficiently bulky to enable displacement of auxiliary supporting base 42 with respect to supporting base 40 to perform tests representative of the usual operating conditions of reader 10.

According to an alternative of the previously-described examples, diagnosis antenna 22 connected to chip 24 has a variable inductance and/or coupling coefficient likely to vary in continuous or discrete fashion. In the last case, diagnosis antenna 22 is for example formed of several spirals, possibly concentric, that can be selectively short-circuited to modify the value of the inductance of diagnosis antenna 22 and/or its coupling coefficient with antenna 14 of reader 10. A spiral can be short-circuited by means of one or several remotely-controlled switches. The simulation of a data exchange between the control circuit of reader 10 and a contactless read card supporting chip 24 and placed at different distances from antenna 14 of reader 10 can then be performed for a same chip 24. Diagnosis antenna 22 may be formed of an assembly of distinct antennas that can, by means of switches, be connected in series or in parallel, one or several antennas of the antenna assembly being further likely to be selectively short-circuited.

According to another alternative of the previously-described examples, diagnosis antenna 22 may be selectively connected to different chips 24. This enables testing reader 10 for different operating conditions with different types of chips.

The present invention has many advantages:

first, it enables performing a diagnosis of a reader in automatic fashion in determined reproducible diagnosis conditions;

second, it enables controlling the progress of the reader diagnosis by a diagnosis center located remotely from the diagnosed reader, the diagnosis center being able to drive the diagnosis of several readers; and

third, it enables in relatively simple fashion performing a diagnosis of a reader for different operating conditions, especially for the reading of different chips and for different contactless read smart card use distances.

Of course, the present invention is likely to have various alterations, modifications, and improvements which will readily occur to those skilled in the art. In particular, the displacements of auxiliary supporting base 42 described in the second and third detailed examples may be combined to test the operation of reader 10.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A contactless card reader (10) comprising an enclosure (12) containing a control circuit connected to a first antenna (14) and capable of remotely exchanging data by the coupling between the first antenna and the antenna of a contactless card, wherein the enclosure contains a diagnosis device (20) comprising a second antenna (22) connected to a test circuit (24) via a switch (26) and means (36, 38) for providing a switch control signal (C), said test circuit being capable, with no presented contactless card, of exchanging data with the control circuit by the coupling of the first and second antennas when the switch is on to perform a diagnosis of the reader.

2. The reader of claim 1, comprising a supporting base (40), the first antenna (14) comprising a spiral at the level of a surface of the supporting base, the spiral delimiting an inner portion of said surface, the second antenna (22) being located at the level of the inner portion.

3. The reader of claim 1, comprising a first supporting base (40), the first antenna (14) comprising a spiral on a substantially planar surface of the first supporting base, and a second supporting base (42), the second antenna (22) being located on a substantially planar surface of the second supporting base.

4. The reader of claim 3, comprising means for displacing the second supporting base (42) with respect to the first supporting base (40) in a direction substantially parallel to the surface of the first supporting base to simulate the presentation of a contactless card at a variable distance from the reader.

5. The reader of claim 3, comprising means for displacing the second supporting base (42) with respect to the first supporting base (40) in a direction substantially perpendicular to the surface of the first supporting base to simulate the presentation of a contactless card at a variable distance from the reader.

6. The reader of claim 1, comprising means for modifying the inductance of the second antenna (22) and/or the coupling coefficient of the second antenna with the first antenna (14) to simulate the presentation of a contactless card at a variable distance from the reader.

7. The reader of claim 6, comprising means for selecting an inductance value of the second antenna (22) and/or of the coupling coefficient of the second antenna with the first antenna (14) from among several discrete values.

8. The reader of claim 1, comprising a first test circuit (24), a second test circuit, and means for connecting the second antenna (22) selectively to the first or to the second test circuit, the first test circuit being capable, when connected to the second antenna, of exchanging data with the control circuit according to first operating conditions of the control circuit, the second test circuit being capable, when connected to the second antenna, of exchanging data with the control circuit according to second operating conditions of the control circuit.

9. The reader of claim 1, wherein the control circuit is connected to the first antenna (14) by a coaxial cable (28, 30), the means (36, 38) for providing the control signal of the switch (26) comprising a low-pass filter connected to the coaxial cable.
